(19) United States
(12) Patent Application Publication
(10) Pub. No.: US 2026/0050005 A1
(43) Pub. Date: Feb. 19, 2026

(54) ACOUSTO-OPTICAL MICRO-ELECTROMECHANICAL SYSTEMS (MEMS) ACCELEROMETER

(71) Applicant: U.S.A as represented by the Secretary of Army, Washington, DC (US)

(72) Inventor: Clinton Blankenship, Redstone Arsenal, AL (US)

(73) Assignee: U.S.A. as represented by the Secretary of the Army, Washington, DC (US)

(21) Appl. No.: 18/807,356

(22) Filed: Aug. 16, 2024

(51) Int. Cl. G01P 15/093; G01P 15/097; G02F 1/33

(52) U.S. Cl. CPC G01P 15/093; G01P 15/097; G02F 1/33

(57) ABSTRACT

The application is directed to a MEMS acousto-optic accelerometer for the detection and measurement of acceleration. The accelerometer is fabricated of optical quality materials using MEMS processing techniques on a substrate. It is comprised of a Bragg cell, proof mass, hinge, light source, and an optical detector. The proof mass of the accelerometer is attached to the substrate by a hinge that allows for pendulous motion under applied acceleration. The Bragg cell is anchored to the proof mass and to the substrate in such a way as to oppose the pendulous motion. The light source is coupled to the Bragg cell whose output is sensed by the optical detector. Force created by the proof mass and acceleration causes a change in the vibrational frequency of the Bragg cell resulting in a change in the frequency of the light sensed by the optical detector, which provides observability of the applied acceleration.

### DEDICATORY CLAUSE

The subject matter of the present application described herein may be manufactured, used and licensed by or for the United States Government for governmental purposes without the payment of any royalties.

### FIELD

The present disclosure relates to an acousto-optic accelerometer, and more specifically, a micro-electromechanical systems (MEMS) accelerometer having enhanced performance through the application of optical techniques.

### BACKGROUND

Current optical MEMS accelerometer technologies are focused primarily on the development of an interferometric sensor such as the Mach-Zehnder interferometer accelerometer as seen in FIG. 1. Devices of this type make use of micro-waveguides or optical fibers 11 on traditional MEMS spring mass damper systems. These systems have been shown to be extremely sensitive to acceleration due to how the measurement is made. Interferometric measurements combine light sources 12 traveling along optical paths, such as waveguides or optical fibers, to produce interference. The sensitivity of an optical interferometer is limited by the noise characteristics of the light source. However, the fabrication of waveguides on the flexures of the accelerometer can prove difficult as it requires several process steps to fabricate the waveguides and flexures while maintaining proper spring constant and requisite transmission properties. This is further complicated when it is desired to fabricate the light source on the same substrate. These systems can also exhibit large temperature induced bias and scale factor sensitivities. Other devices attempt to use intensity response of reflected light from the vertical or horizontal surface of typical MEMS accelerometer designs, or they attempt to create a resonant optical cavity to track the frequency shift due to a force induced change in cavity length.

Therefore, there is a need for an improved MEMS accelerometer and method for detecting acceleration that increases performance in scale factor, noise, and bias performance.

### SUMMARY

The present application pertains to the field of MEMS optical inertial sensors, and more particularly to an advanced MEMS accelerometer that utilizes optical materials and optical techniques to enhance various sensor performance parameters, such as bias, noise and scale factor.

More specifically, the present disclosure provides a MEMS accelerometer system comprising a mounting substrate, a reference mass (also referred to herein as a “proof mass”), an optical detector, a light source, and a frequency modulator. The reference mass is configured to move within a reference mass path. The light source emitting a light through the frequency modulator and subsequently to the optical detector. The reference mass is configured to impart a force on the frequency modulator, thereby changing the frequency of the light going through the frequency modulator. The change in frequency being proportional to the change in acceleration experienced by the system.

Other aspects will be in part apparent and in part pointed out hereinafter.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic representation of a Mach-Zehnder interferometer accelerometer, a depiction of the functional components of the prior art;

FIG. 2 is a schematic representation of a MEMS accelerometer that measures pendulous movement;

FIG. 3 is a schematic representation of a MEMS accelerometer that measures linear movement;

FIG. 4 is a schematic representation of a MEMS accelerometer that operates in an open loop configuration; and

FIG. 5 is a schematic representation of a MEMS accelerometer that operates in a closed loop configuration.

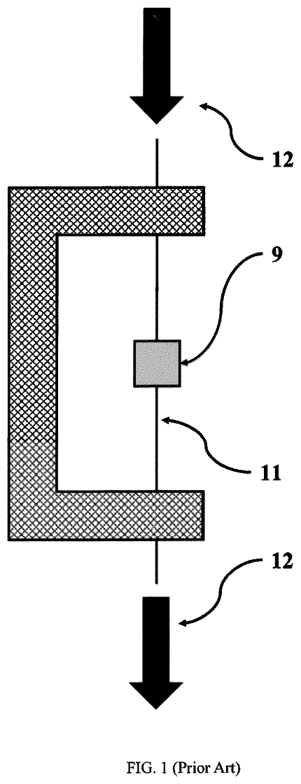

Corresponding parts are given corresponding reference characters throughout the drawings.

Reference is made in the following detailed description of preferred embodiments to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible. At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

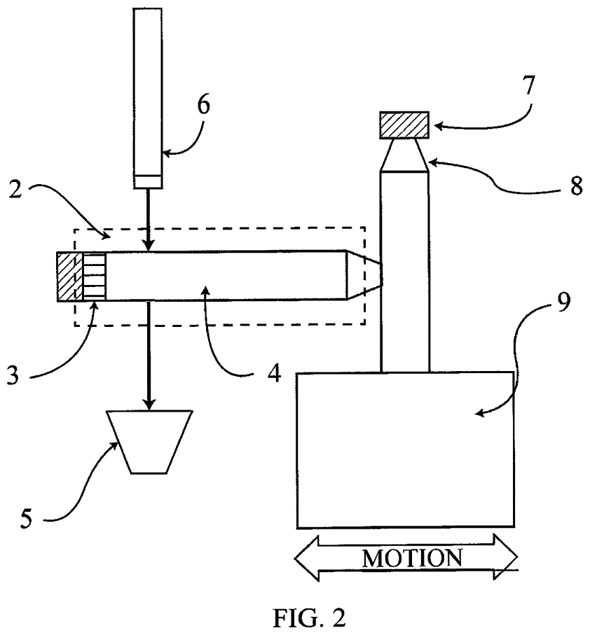

FIG. 2 shows a first embodiment of a MEMS accelerometer 1, comprising a light source 6, a frequency modulator 2, an optical detector 5, and a proof mass 9. As explained more fully below, the light source 6 is configured to output light along a light path toward the optical detector 5. The frequency modulator 2 is positioned in the light path to modulate the frequency of the light. As used herein, the term “modulation” or “modulate” refers to the variance in the amplitude, phase and/or frequency of a signal. For example, the modulation may be from about 2 MHz to about 1000 MHz, from about 2 MHz to about 500 MHz, from about 5 MHz to about 200 MHz or from about 10 to about 100 MHz. The proof mass 9 is configured to act on the frequency modulator 2 with force proportional to acceleration, and the frequency modulator is configured to react to the force in such a way that the modulated frequency of the light is a function of acceleration. Hence, the frequency detected by the detector 5 indicates acceleration of the proof mass 9.

Suitably, all of the components of the MEMS accelerometer 1 are supported on a substrate (not shown) at an anchor point 7. The MEMS accelerometer 1 can be fabricated on the substrate using standard MEMS processing techniques. Examples of substrates include, but are not limited to, silicon, silicon dioxide, silicon nitride, quartz and lithium niobate. Optical MEMS may be fabricated using a number of different process or any of the substrate identified above. Standard MEMS processing includes chemical vapor deposition (CVD), physical vapor deposition (PVD), lithography, wet etching processes, and dry etching process, such as Deep Reactive Ion Etching (DRIE) or lithographie, galvanoformung, abformung (LIGA).

In the illustrated embodiment, the frequency modulator 2 is a Bragg cell comprising an optical transmission medium 4, a transducer 3, and an acoustic absorbing material. In general, a Bragg Cell is an acousto-optic modulator that uses acoustic waves to shift the frequency of light. The optical transmission medium 4 comprises a crystalline structure that changes in response to forces imparted on the optical transmission medium. In one embodiment, the transducer 3 is a piezoelectric transducer that emits acoustic waves by means of the piezoelectric effect. The piezoelectric transducer 3 emits acoustic waves which output an acoustic wave to drive vibration of the optical transmission medium 4 which in turn change the frequency of light waves that pass through the frequency modulator 2. A separate transducer can be eliminated if the optical transmission medium is piezoelectric and can be driven sufficiently to modulate the light.

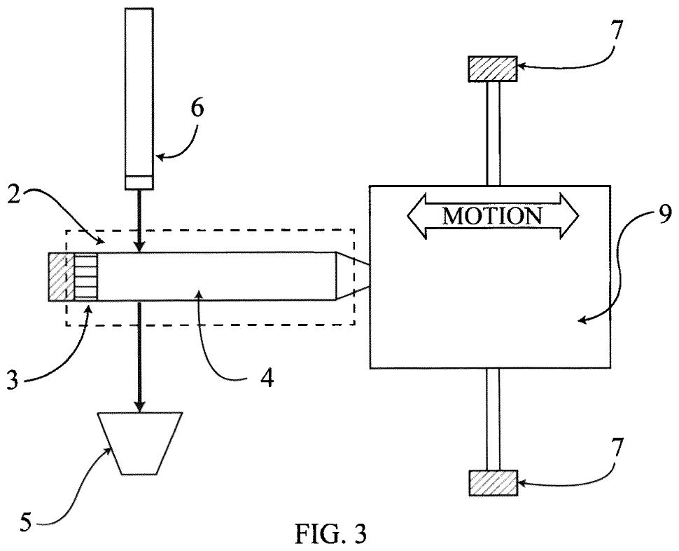

In the illustrated embodiment, the proof mass 9 is configured to move in response to an applied acceleration. The proof mass 9 is coupled to the frequency modulator 2 to act on the frequency modulator as it moves. The force imparted by the proof mass 9 onto the optical transmission medium 4 changes the crystalline structure of the optical transmission medium, which changes the vibrational frequency of the frequency modulator 2. An alternative embodiment can be designed such that the applied acceleration changes the structure of the piezoelectric driver as a means to modify the vibrational frequency. In one embodiment shown in FIG. 2, the proof mass 9 is connected to the substrate (not shown) by a hinge 8, which allows for pendulous motion in relation to the substrate under applied acceleration. In a secondary embodiment shown in FIG. 3, the proof mass 9 is connected to the substrate (not shown) by one or more flexures 10.

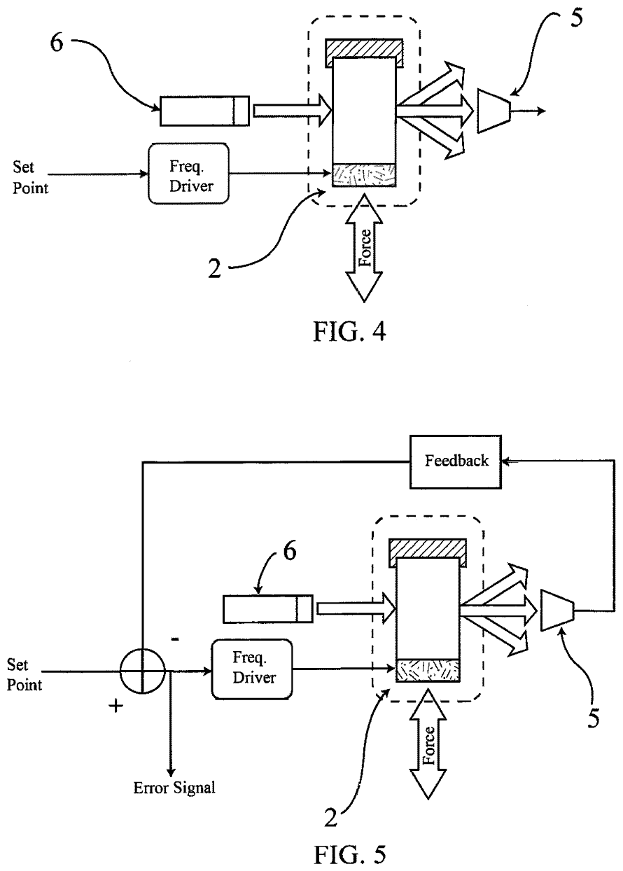

FIG. 4 shows an open loop configuration of the frequency modulator, in which the proof mass 9 applies a force to the frequency modulator 2. This force causes changes in the frequency modulator 2, particularly a change to the crystalline structure and vibrational frequency of the optical transmission medium 4. As a result, the frequency modulator 2 modulates the light differently so that the light output from the modulator to the detector 5 has a different frequency. The modulation of the light frequency is detected by the optical detector 5, and the detector outputs a signal representative of the acceleration acting on the MEMS accelerometer. FIG. 5 shows a closed loop configuration, in which the frequency modulator 2 comprises a transducer 3 having a frequency drive and a proportional controller. The transducer 3 is driven to a set frequency by said frequency driver. Under acceleration the proof mass 9 applies a force to the frequency modulator 2. This force causes changes in the frequency modulator 2 and the propagation of the acoustic waves through the optical transmission medium 4. The resulting optical detector output is fed back to the proportional controller which measures the variation between the set frequency and the measured frequency. The optical detector output is directed back to the frequency drive in order to maintain the set point.

The variation as measured by the proportional controller becomes the output signal proportional to acceleration.

One with a basic knowledge of the art could conceive a number of electronic or opto-electric interfaces for the control loop and the processing of acceleration data.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

The foregoing description has been presented for the purposes of illustration and description. It is not intended to be exhaustive or to limit the disclosure to the precise form disclosed. Many modifications and variations are possible in view of this disclosure. Indeed, while certain features of this disclosure have been shown, described and/or claimed, it is not intended to be limited to the details above, since it will be understood that various omissions, modifications, substitutions and changes in the apparatuses, forms, method, steps and system illustrated and in its operation can be made by those skilled in the art without departing in any way from the spirit of the present disclosure.

Further, the foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments of the present disclosure are presented for purposes of illustration and description. They are not intended to be exhaustive or to limit the disclosure to the precise forms disclosed, many modifications and variations are possible in view of the above teachings. The embodiments were chosen and described in order to best explain the principles of the disclosure and its practical applications, to thereby enable others skilled in the art to best utilize the disclosed system and method, and various embodiments with various modifications as are suited to the particular use contemplated.

What is claimed is:

1. A MEMS accelerometer comprising:
a light source for emitting light along a light path;
an optical detector positioned in the light path for detecting a frequency of the light;
a proof mass configured to move in response to acceleration; and
a frequency modulator positioned in the light path for modulating the light emitted by the light source to have a modulated frequency, the frequency modulator positioned in relation to the proof mass such that the proof mass imparts force on the frequency modulator when the proof mass moves in response to acceleration, the frequency modulator configured to adjust the modulated frequency in response to the force imparted by the proof mass such that the modulated frequency is a function of the acceleration.

2. The MEMS accelerometer of claim 1, wherein the frequency modulator comprises an optical transmission medium having a crystalline structure that changes in response to the force imparted by the proof of mass.

3. The MEMS accelerometer of claim 2, wherein the crystalline structure of the optical transmission medium modulates the frequency of the light.

4. The MEMS accelerometer of claim 3, wherein frequency modulator further comprises a transducer configured to output an acoustic wave to the optical transmission medium.

5. The MEMS accelerometer as set forth in claim 4, wherein the frequency modulator is a Bragg cell.

6. The MEMS accelerometer of claim 4, wherein the frequency modulator comprises an acoustic absorbing material cooperatively coupled to the optical transmission medium.

7. The MEMS accelerometer of claim 1, further comprising a substrate, the proof of mass being connected to the substrate.

8. The MEMS accelerometer of claim 7, wherein the proof of mass is pendulously connected to the substrate by a hinge.

9. The MEMS accelerometer of claim 7, wherein the proof of mass is connected to the substrate by a flexure.

10. The MEMS accelerometer of claim 1, further comprising a substrate and a linear constraint connecting the proof of mass to the substrate for linear movement in relation to the substrate.

11. The MEMS accelerometer of claim 1, wherein the MEMS accelerometer is an open loop system.

12. The MEMS accelerometer of claim 11, wherein the MEMS accelerometer is configured to output a signal representative of acceleration based on the frequency of the light detected by the detector.

13. The MEMS accelerometer of claim 1, wherein the MEMS accelerometer is a closed loop system having a proportional controller.

14. The MEMS accelerometer of claim 13, wherein the frequency modulator comprises a transducer having a frequency drive.

15. The MEMS accelerometer of claim 14, wherein the optical detector outputs a signal representing the detected frequency to a proportional controller configured to output a control signal to the frequency drive.

16. The MEMS accelerometer as set forth in claim 2, wherein the optical transmission medium is piezoelectric material.

17. A method of measuring an acceleration, comprising:
emitting light along a light path;
modulating the light emitted along a light path using a frequency modulator;
imparting force on the frequency modulator proportional to acceleration such that a frequency of the modulated light is a function of the force; and
detecting the frequency of the modulated light.
